(19) United States
(12) Patent Application Publication
(10) Pub. No.: US 2006/0034255 A1
(43) Pub. Date: Feb. 16, 2006

(54) Telephone and Internet communications system

(76) Inventors: Gordon Douglas Benning, Ottawa (CA); Loren Ray Smart, Arnprior (CA)

Correspondence Address: MILTON, GELLER, LLP, 700 - 225 METCALFE STREET, OTTAWA, ON, K2P-1PG, CA

(21) Appl. No.: 10/916,398

(22) Filed: Aug. 12, 2004

(51) Int. Cl. H04L 12/66

(52) U.S. Cl. 370/352

(57) ABSTRACT

An existing voice band data and voice communication source, such as a residential alarm panel or point-of-sale credit/debit card reader, that includes a user phone for voice communication and which is connected through a telephone line and telephone central office to a remote receiving center through the telephone system, is provided with a communication interface coupled to said source that comprises means for enabling communication to occur over the Internet concurrently with the use of the telephone network. The system includes default circuitry which directs data communication from the source to the remote receiving center through the Internet while the Internet link is operative, and which, in the condition of a failure of the Internet link, connects both data and voice signals from the communication source for transmission of signals through the telephone network.

### FIELD OF THE INVENTION

This invention relates to a system for facilitating communication over both the existing wire-based voice band telephone network and the Internet. More particularly, it addresses an electronic module for adapting existing voice band telephone-based communications systems to operate additionally through use of the Internet.

### BACKGROUND TO THE INVENTION

Presently, many millions of communications units exist that are designed to alternately allow data signals and voice communications to be transmitted over the standard telephone network, in the standard 0 to 4 khz voice band. As an example, residential and industrial security systems communicate with a remote monitoring center using the standard telephone lines in order to provide an alarm. An alarm may be based upon the detection of an intruder through the use of motion sensors, electric eyes and the like. Other examples include systems, such as HVAC (Heating, Ventilation and Air Conditioning) units, which also use telephone dial up monitors to control environmental conditions within a building. These and other similar systems all qualify as data communications sources.

The existing systems also generally allow standard voice communication to occur over the same telephone lines that are used to transmit alarm signals. However, as voice and data messages cannot be sent at the same time over telephone lines using the standard voice band, existing alarm panels are provided with circuitry which allows them to seize or take-over control of a telephone line, suppressing voice communications when it is time to send an alarm. In many existing arrangements, if it is desired to ensure uninterrupted telephonic voice communications during an alarm condition, multiple telephone lines must be employed.

A typical residence equipped with such a shared-line system includes an alarm panel which is connected to the telephone network. The phone system in the house is fed to the telephone network through the alarm panel. In this way, the alarm panel can interrupt voice calls when it needs to seize the telephone line. A disadvantage of this system is that the phone cannot be used for verbal communications while an alarm is being transmitted.

As an alternative to using the telephone system, it is known to employ data transmission lines that are connected and deliver messages over the Internet. An advantage of using the Internet is that simultaneous voice and data communications can be supported. Thus, in an Internet-based security system, a user may speak verbally with persons at the monitoring center even while an alarm condition is being reported, and even while the monitoring center is using the Internet connection to obtain further information from the premises concerning the source of the alarm.

Both a telephone-based and an Internet based communications system are vulnerable to loss of the communication link through the nefarious cutting of the relevant wires or cables. An advantage of an Internet-based system is that, by effecting regular polling of the user interface on customer premises, a monitoring center may quickly detect such an interruption of communication. While a similar polling procedure can be effected telephonically, that alternative is costly and will deny use of the telephone lines for other purposes such as voice communications.

A need therefore exists for a dual telephonic and Internet communications system, which can be retrofitted to existing alarm systems with minimum effort. This will allow a customer to improve and extend the lifespan of devices currently designed to work over the standard voice band telephony system by interfacing them to the Internet. Such a dual system should ideally allow for regular polling of the local alarm panel, while permitting simultaneous use by householders of their telephones. Such a system should also, in the event of failure of the Internet connection, allow all communications to revert to that existing previously, based upon the telephone network.

Many stores presently employ the telephone network to obtain clearances for the use of credit cards. Unless multiple telephone lines have been installed, while credit card data is being transmitted using voice band communications, engaging in voice communications over the same telephone line is not possible. Conversely, if voice communications are taking place, or are attempted during a data transmission, the data transmission is not effective.

A need exists for a system that can be installed with a minimal adjustment to the existing equipment that will allow the simultaneous use of telephonic communications and data transmissions in respect to such point-of-sale data sources.

In these and other similar situations, it is desirable not only that such simultaneous communication is available, but also that, in the event of the failure of the Internet system, the installed equipment be able to revert to its previous configuration as a default.

Many existing data source transmission units also incorporate keypads for controlling such units. A security system might provide one or more keypads to enable and disable activation of the system. Furthermore, existing units also include, in many cases, plug-in access for the addition of even further keypads. It is known to use keypads which remotely access units over the Internet. This is a convenience for owners who wish to reconfigure their data source transmission units from a remote location. It would be desirable in any modifications to such systems to maintain this functionality.

The present invention addresses the objects of overcoming the inconveniences of the previous system and provides a ready means for adapting existing, installed equipment to simultaneously take advantage of the voice band telephone and Internet communication networks.

In U.S. Pat. No. 6,452,490 issued Sep. 17, 2002, the contents of which are incorporated herein by reference, the inventors disclose an alarm system that uses strings of DTMF digits on a telephone line to communicate between CP security equipment and an end office (a monitoring center). The end office then uses packetized communication to advise alarm-monitoring stations such as firehouses, police stations, hospitals or personal contacts of an alarm situation.

In U.S. Pat. No. 6,727,811, issued Apr. 27, 2004, the contents of which are incorporated herein by reference, the inventors describe a system connectable to the world wide web (WWW) or the Internet, and operable to send an alarm electronic message over the WWW or the Internet. The disadvantage of such a system is that it cannot be easily adapted to use existing DTMF or analog CP alarm system equipment. This would imply that a customer having DTMF or analog CP alarm equipment and wanting to use the disclosed invention would have to purchase CP alarm equipment compatible with the teachings of this reference.

In U.S. Pat. No. 6,281,790 issued Aug. 28, 2001, the contents of which are incorporated herein by reference, the inventors disclose systems and methods for remotely monitoring sites by use of the Ethernet or Internet networks. The disclosure does not address the issue of using existing DTMF or analog CP alarm system equipment.

In U.S. Pat. No. 6,690,411 issued Feb. 10, 2004, the contents of which are incorporated herein by reference, the inventors disclose a system and method for enabling a central station to verify in real-time whether an alarm signal generated by a security base station is a false alarm. The invention also teaches how to enable remote users to access features of the security base station. The disclosure does not address the issue of using existing DTMF or analog CP alarm system equipment.

The invention in its general form will first be described, and then its implementation in terms of specific embodiments will be detailed with reference to the drawings following hereafter. These embodiments are intended to demonstrate the principle of the invention, and the manner of its implementation. The invention in its broadest and more specific forms will then be further described, and defined, in each of the individual claims, which conclude this Specification.

### SUMMARY OF THE INVENTION

According to the present invention, in one aspect an interface is introduced between an existing voice band data and voice communication source which has previously been connected to a remote receiving center through the telephone voice band system. While the invention may accept data which is already IP packetized or other high-speed data, its application is particularly suited to cases where the data source supplies data as voice band data, formatted for use on the standard telephone network.

The interface of the invention introduces, as one aspect, the feature of permitting communication to occur over the Internet either alternatively to use of the telephone network or concurrently with the use of the telephone network. Preferably, the interface is introduced by intercepting the telephone line extending between the existing source and the telephone central office, and additionally, the interface is connected to the user phone used for voice communication through a link which does not disrupt the ability of the user phone to be reconnected to the telephone network in the event of failure of the Internet connection.

According to another aspect of the present invention, the interface incorporates circuitry that directs voice band data communication from the source to the remote receiving center through the Internet while the Internet link is operative. But the interface also incorporates circuitry which, in the condition of a failure of the Internet link, re-connects both data and voice signals from the communication source for transmission of signals through the telephone network.

Optionally, while both the telephonic and Internet link are operative, the interface may direct telephonic voice communication through either or both links.

According to one preferred variant, the existing data and voice communication source is an alarm panel for a security system that includes a user phone and the remote receiving center is a security-monitoring center. In this variant the security-monitoring center may use the Internet to regularly and repeatedly poll the alarm panel/interface to ensure that the communications links there between have integrity. When the alarm panel/interface fails to respond to a polling prompt, the security-monitoring center may then react equivalently to a condition wherein an alarm has been transmitted.

According to another preferred variant, the existing data and voice communication source is a Point of Sale data terminal, such as a credit/debit card data transmitter which includes a user phone, and the remote receiving center is a credit/debit card or PoS verification office. In this variant, while both the telephonic and Internet link are operative, the interface may direct telephonic voice communication through either or both links. Upon failure of the Internet link, the interface also incorporates circuitry which connects both data and voice signals from the credit card data transmitter and a user phone for transmission through the telephone network.

Accordingly, in a further aspect, it is a feature of the invention in either type of case that, in the event of failure of the added Internet connection, the existing system may revert and operate over the pre-existing telephonic network connections that were in place before the introduction of the new interface of the invention.

As a further feature, the invention is applicable in many existing systems which include data source transmission units that incorporate a keypad input for controlling such units. In such cases, the interface of the invention may be connected to such keypad input so as to provide remote keyboard access to the data source transmission unit through the Internet link. Thus, a remote workstation can, through the Internet, be used to transmit command signals for controlling a remote system, such as an alarm or HVAC system.

The foregoing summarizes the principal features of the invention and some of its optional aspects. The invention may be further understood by the description of the preferred embodiments, in conjunction with the drawings, which now follow.

### BRIEF DESCRIPTION OF THE DRAWINGS

FIG. 1 is a schematic depiction of a prior art residential or industrial alarm connected through the telephone network to an alarm-monitoring center.

FIG. 2 is a schematic depiction of a prior art credit card reader connected through the telephone network to a credit card monitoring center.

FIG. 3 is a schematic depiction of the interface of the invention when combined with the alarm system of FIG. 1

FIG. 4 is a schematic depiction of the system as in FIG. 3 wherein the voice data from the user phone is transmitted to the telephone office through the telephone network and the alarm data information is transmitted to the monitoring equipment through the Internet.

FIG. 5 is a schematic depiction of the system as in FIG. 3 wherein the Internet connection has failed and the alarm reverts to the telephone network.

FIG. 6 is a schematic depiction of the system as in FIG. 3 wherein an additional keypad and remote PC with alarm panel control software have been added to the system.

FIG. 7 is a schematic depiction of the system as in FIG. 2 wherein the interface of the invention has been combined with the Point of Sale terminal and user phone.

FIG. 8 is a schematic depiction of the system as in FIG. 8 wherein the data from the Point of Sale terminal has is being transmitted to the monitoring equipment through the Internet and the voice communications from the user phone are transmitted through the telephone network.

FIG. 9 is a schematic depiction of the system as in FIG. 8 wherein the Internet connection has failed and the data from the Point of Sale terminal is being transmitted through the telephone network.

FIG. 10 is a schematic depiction of the circuitry used to create the customer premises interface module used to allow the voice band data communications to be transferred via the internet, item 20 in the diagrams, showing the circuit elements used and their connectivity.

FIG. 11 is a schematic depiction of the circuitry used to create the head end or central monitoring interface used to allow the voice band data communications to be transferred via the internet to the communications source of FIG. 1.

### DESCRIPTION OF THE PREFERRED EMBODIMENT

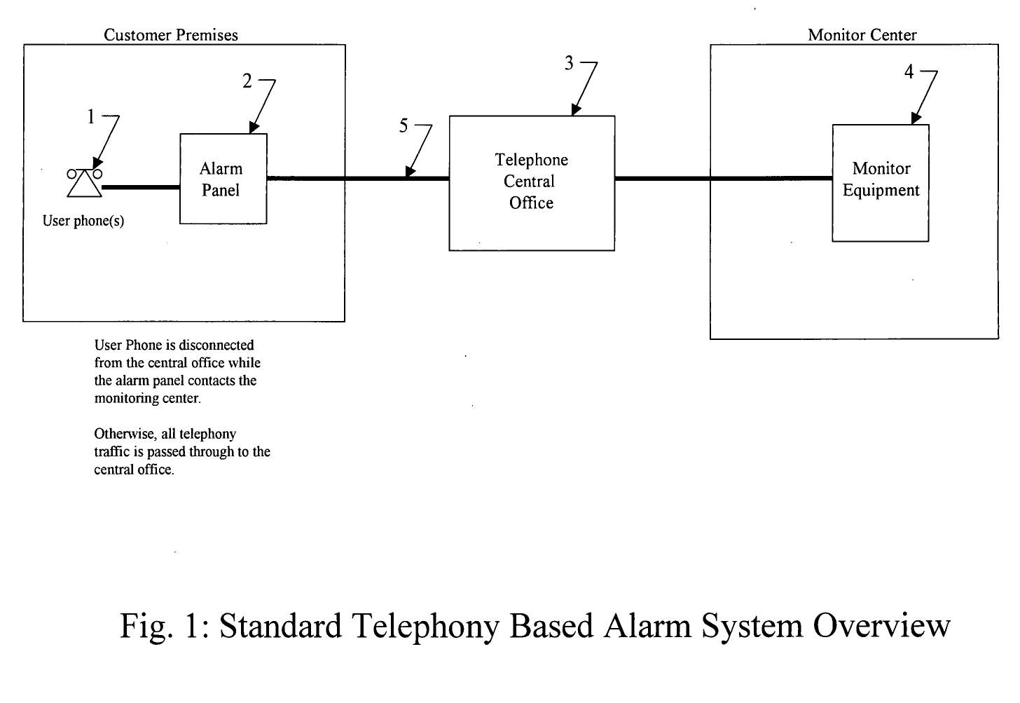

FIG. 1 depicts the prior art case wherein a user's telephone 1 is connected to a voice band home alarm system panel 2 which is connected through the general telephone lines 5 to the telephone network's central office 3 to reach the monitoring equipment 4 of the monitoring company. In this case, when an alarm is triggered, the user phone 1 is disconnected from the telephone network's central office 3 by the alarm panel 2 so that the monitoring equipment 4 can be in constant contact with the homeowner's alarm panel. The alarm panel 2 is an exemplary source for data communication.

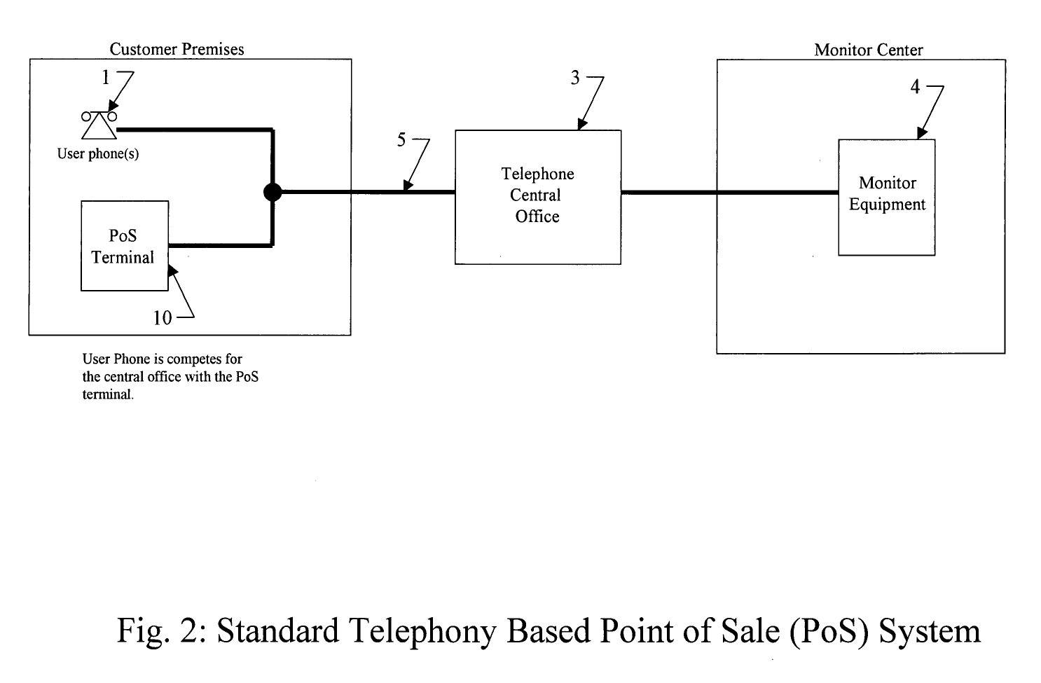

FIG. 2 depicts a second prior art case of an alternate source for data communication wherein a Point of Sale (PoS) Terminal 10, which includes a user phone 1, is installed in such a manner that it is able to transmit credit card information or a user's voice communication through a single voice band phone line 5. The limitation of this system is that the voice communication and the credit card information cannot be transmitted simultaneously; the telephone line 5 can only be used to either dial a voice communication from the user phone 1 or to dial in information from a credit card request at a given moment.

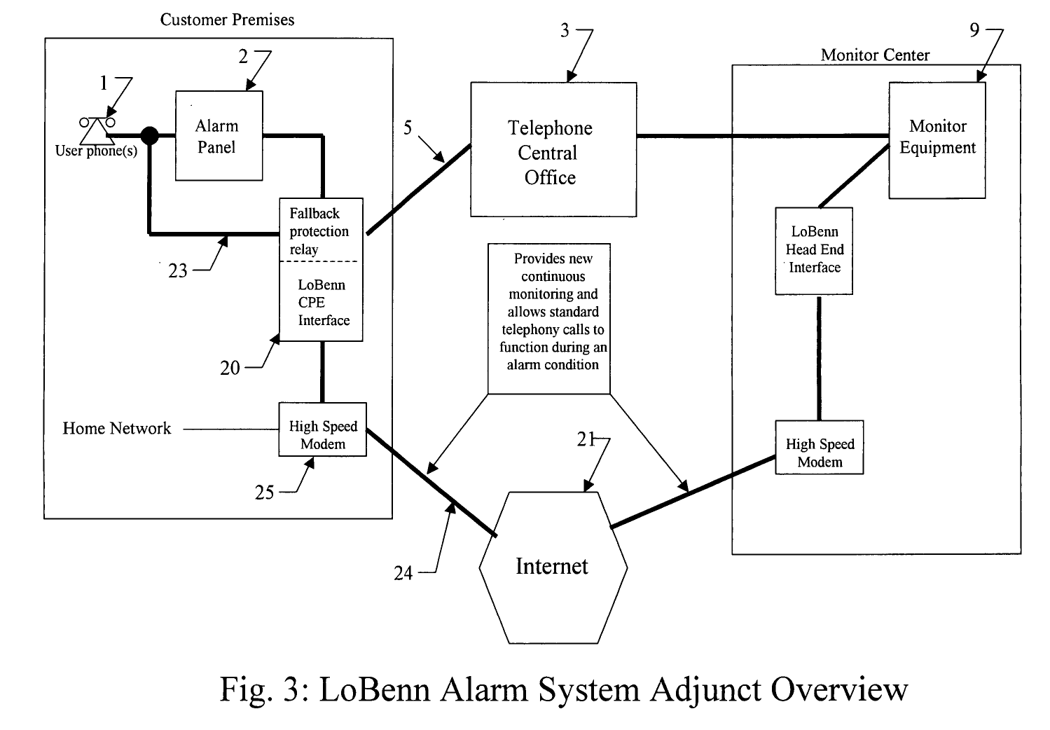

In one preferred embodiment of the present invention as depicted by FIG. 3, an interface 20 is introduced between an existing telephone 1 and alarm panel 2, which have previously been connected to a remote receiving center through the telephone central office 3. The interface 20 introduces the feature of permitting communication to occur over the Internet 21 either as an alternative to use of the telephone network 3, or concurrently with the use of the telephone network 3. Preferably, the interface is introduced by intercepting the telephone line 5 extending between the existing source 2 and the telephone central office 3. Additionally, the interface 20 is connected to the user phone 1 used for voice communication through a link 23. Through this link the interface 20 allows the phone 1 to be connected to the telephone central office even when an alarm is being transmitted over the Internet 21. Further, the interface 20 allows the data source 2 to be reconnected to the telephone network 3 in the event of failure of the Internet connection 24.

Using the system of FIG. 3, with software adjustments, it is also possible to modify the system to allow the user voice/communication telephone to be routed, through the interface of the invention, over the Internet. In such case, both the telephone and data information are converted to packet data to be sent onto the Internet. At the monitoring center, the system then redirects the voice calls, appropriately reformatted, for delivery over the telephone network.

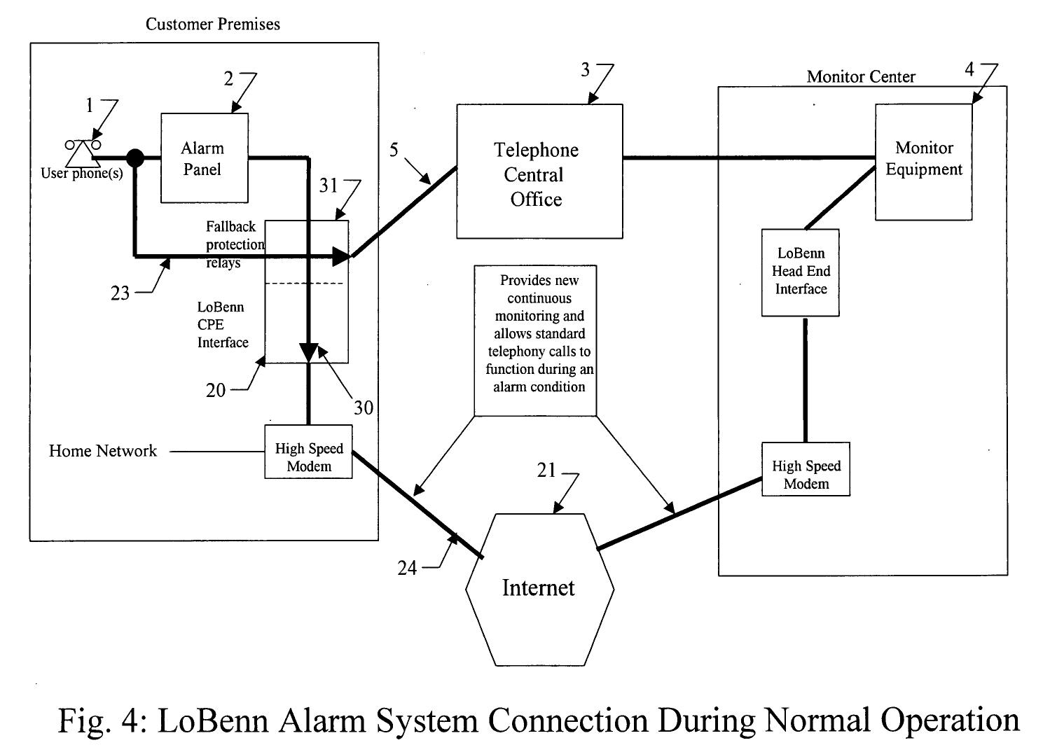

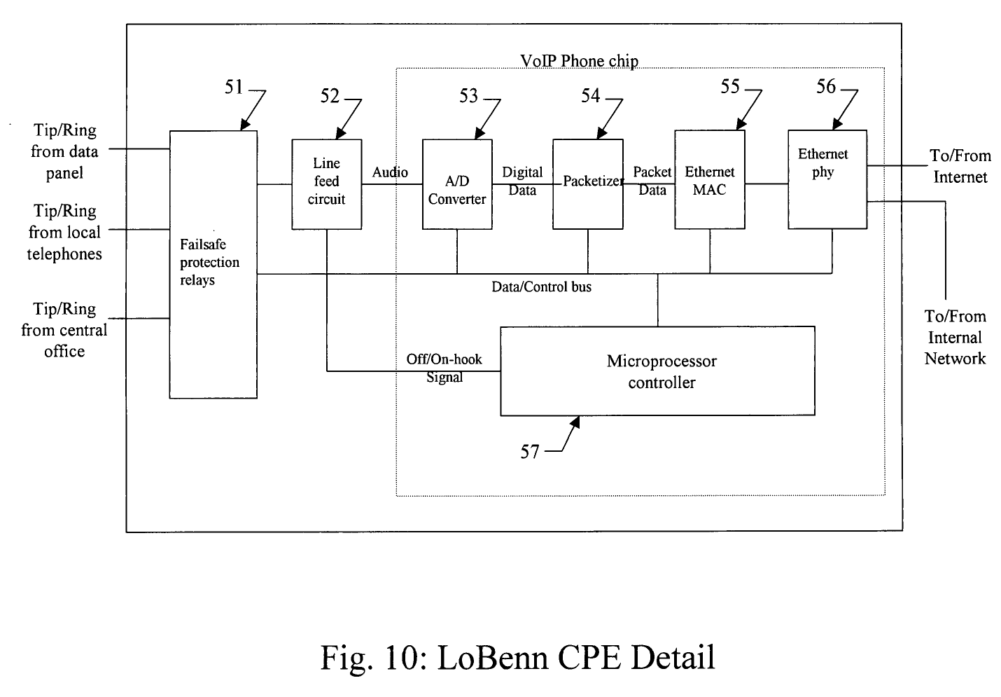

As seen in FIG. 4, the interface 20 incorporates circuitry (see FIG. 10, below) that directs data communication from the source 2 to the remote receiving center 4 through the Internet 21, while the Internet link 24 is operative. While said link 24 is operative, the voice communications may be directed by the interface 20 either through the telephone central office 3 or through the Internet link 24. While both the telephonic and Internet link are operative, the routing circuitry would preferably, normally, direct telephonic voice communication through the telephonic link. This is actually the standard operating mode of a standard system. According to this preferred variant of the invention, the voice calls will continue to use the standard telephone interface while the data calls will be intercepted by interface and routed via the Internet. Advantageously, the system of the invention allows such routing to occur simultaneously.

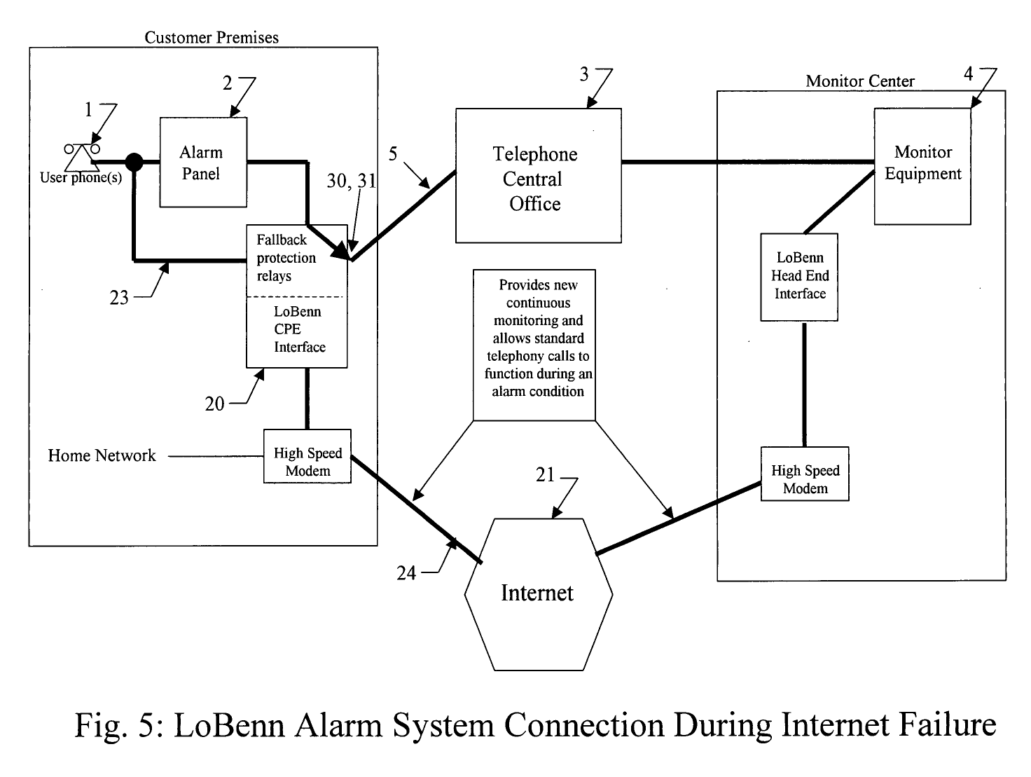

FIG. 5 shows that in the condition of a failure of the Internet link 24, the interface 20 incorporates circuitry that allows both data 30 and voice 31 signals from the communication sources 1, 2 to be transmitted, alternately, through the telephone network 3.

In the case depicted by FIGS. 3 and 4, the security-monitoring center 4 is able to use the Internet 21 to regularly and repeatedly poll the interface 20 to ensure that the communications links have an acceptable level of integrity. When the interface 20 fails to respond to a polling prompt, the security-monitoring center 4 may then react equivalently to a condition wherein an alarm has been transmitted.

Optionally, while both the telephonic link 5 and Internet link 24 are operative, the interface may direct telephonic voice communication through either or both links.

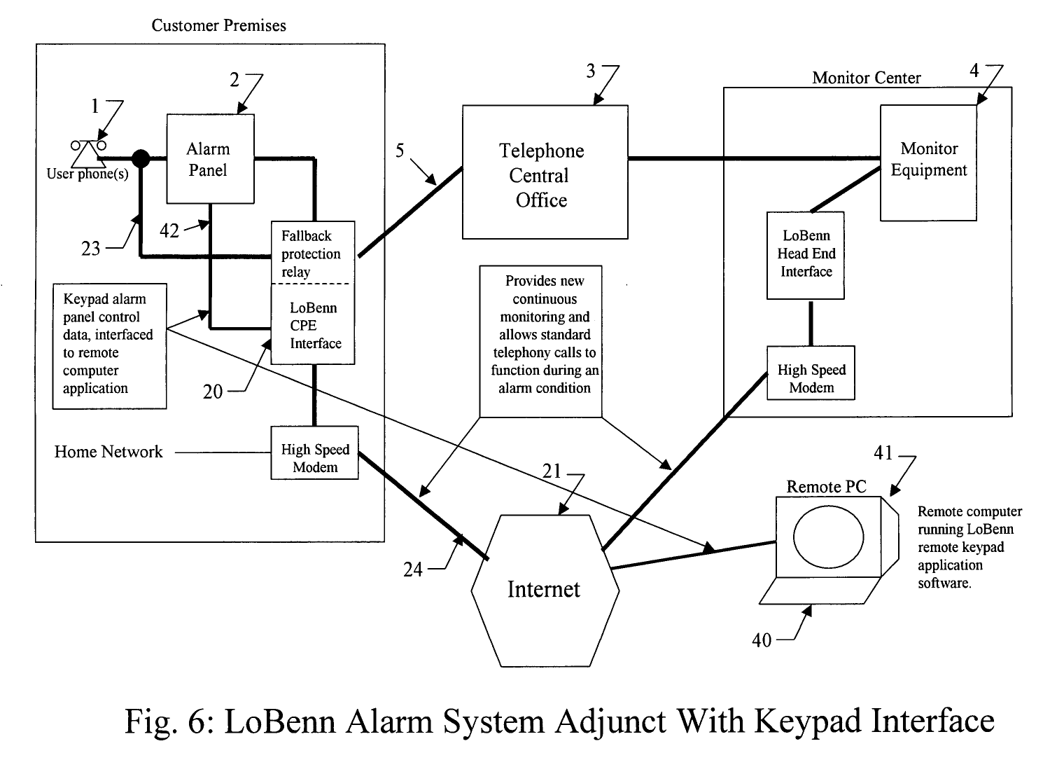

Existing systems include data source transmission units that incorporate a keypad input for controlling such units. In such cases, as shown in FIG. 6, the interface may be connected to such keypad input 40 forming part of a remote personal computer (PC) so as to provide remote keyboard access to the data source transmission unit through the Internet link 24. As shown in FIG. 6, this remote workstation 41, when connected to the Internet 21, is able to transmit command signals for controlling the alarm system 2 through a link 42 between the alarm panel and the interface. This provides for the delivery of remote commands, such as scheduling instructions as to when the alarm is to be armed or disarmed for designated areas.

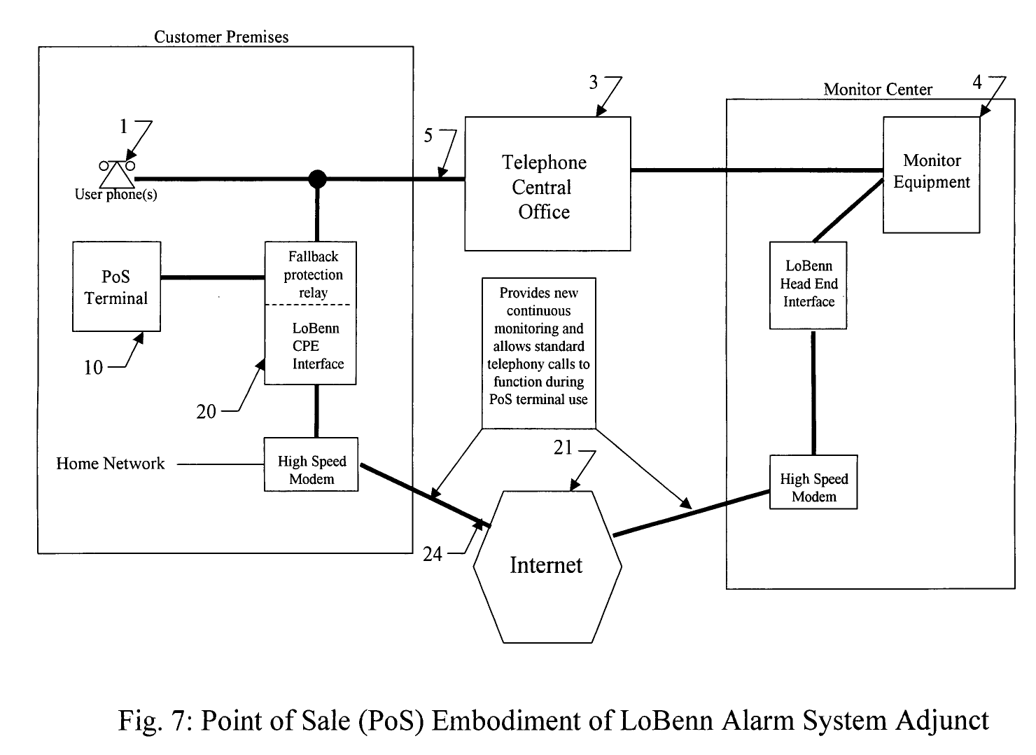

In FIG. 7, a further embodiment of the invention is depicted wherein the existing data and voice communication source is a credit card data transmitter 10 which includes a user phone 1 and the remote receiving center 4 is a credit card verification office. In this variant, while both the telephonic link 5 and Internet link 24 are operative, the interface may direct telephonic voice communication through either or both links 5, 24.

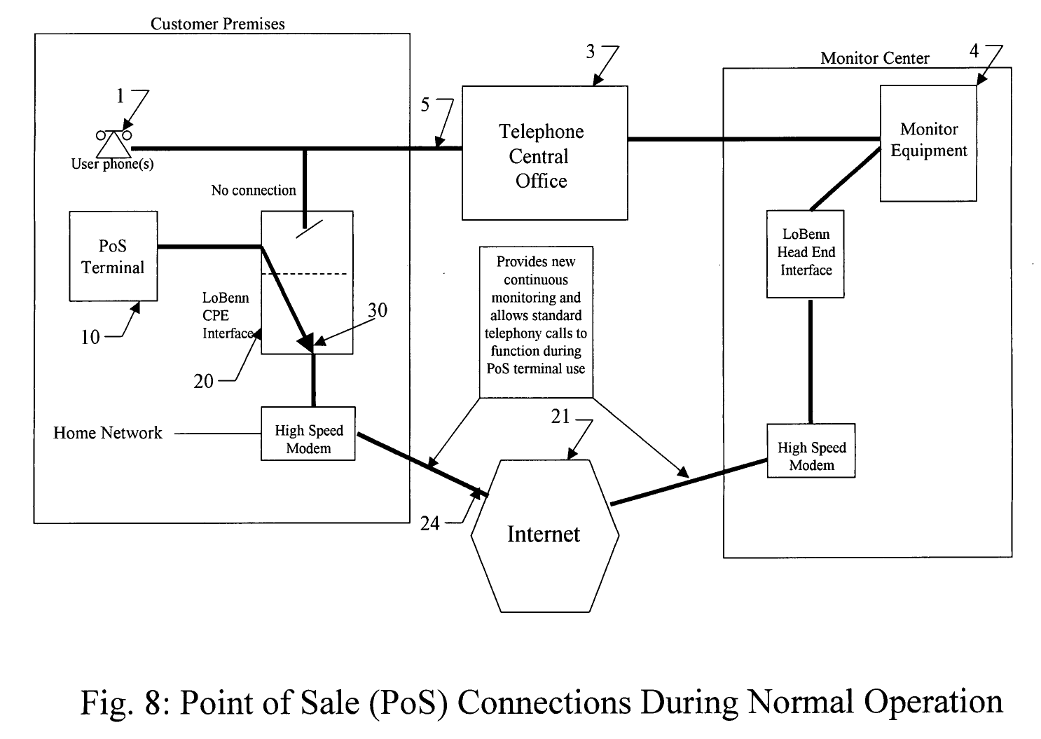

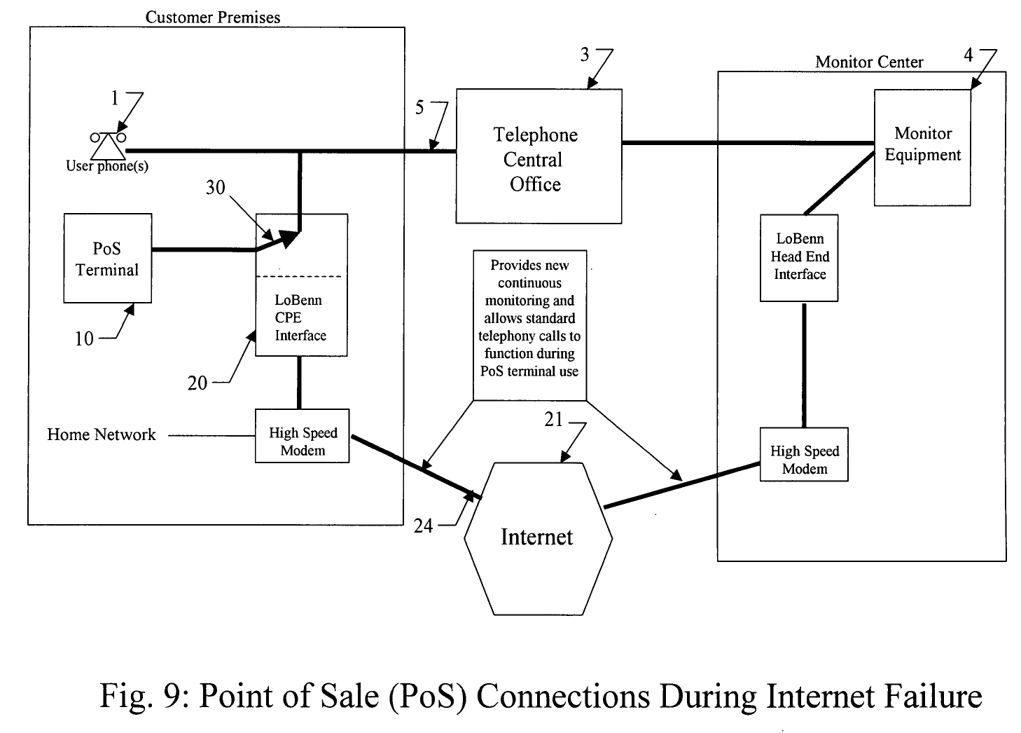

FIG. 8 depicts the case wherein interface 20 transmits the credit card information to the remote receiving center 4 through the Internet, while the voice communications from user phone 1 are transmitted through the telephone network 3. Should the Internet link 24 fail as in FIG. 9, the interface 20 incorporates circuitry that will connect both data and voice signals, alternately, from the credit card data transmitter 10 and a user phone 1 for transmission through the telephone network 3.

FIG. 10 shows a block diagram of the circuit elements that comprise the CPE interface 20 in the previous diagrams. This circuitry receives analog and voice band data from the communications source and converts one or both into packetized signals for transmission over the network. It also effects the reverse process of receiving packetized signals from the network for conversion and delivery to the original communications source, the communications being bi-directional.

The failsafe protection relays 51 are composed of an set of relays which in normal operation facilitate the connection of the data panel output to the packetizing interface, while allowing the user telephone to remain connected to the telephone system. The microprocessor elements of both the CPE and head end interface will contain code that will regularly test the validity of the Internet connectivity. Should a failure be detected, the failsafe relays will be commanded to connect the user system directly to the telephone system, as it was originally installed.

The Line Feed circuit element 52 will emulate the telephone office interface to the data panel, allowing it to appear as though still connected to the central office. This interface will provide battery feed and loop current to the data panel, and will signal the microprocessor in the event that it detects an off-hook state at the panel, i.e. the panel would like to initiate a call to the central office.

The A/D converter element 53 will convert the analog signals from the data panel to time division multiplexed digital data words, for transmission over the internet, and conversely will accept digital data words from the internet, via the packetizer element, to be converted to analog signals which are then transmitted back to the data panel.

The Packetizer element 54 will, under the control of the microprocessor, group the digital data words from the A/D converter, and using information programmed by the user and transmitted from the head end controller, prepare properly encrypted and addressed data packets to be sent to the head end via the internet. Conversely, it will accept data packets from the internet, decrypt the packets, and using information programmed by the user and supplied by the head end, select packets addressed for the CPE elements use, ungroup the data packets, and present the raw data words to the A/D converter element, for interface to the data panel.

The Ethernet MAC 55 and phy 56 elements convert the data packets to/from industry standard Ethernet format, under control of the microprocessor.

An example of one embodiment of the above circuit elements is a Voice over IP phone chip, currently available from a number of semiconductor vendors.

During normal operation, where both the Internet and the telephone system are operational, the failsafe protection relays will direct the data from the connected device to the line feed circuitry. When an active condition is detected, the CPU will direct the circuitry to convert the incoming voice band data to packet information for transmission to the internet, and will accept incoming packet information and convert it to voice band data to transmission to the user equipment, facilitating full communication via the packet based internet as opposed to the voice band analog telephone system.

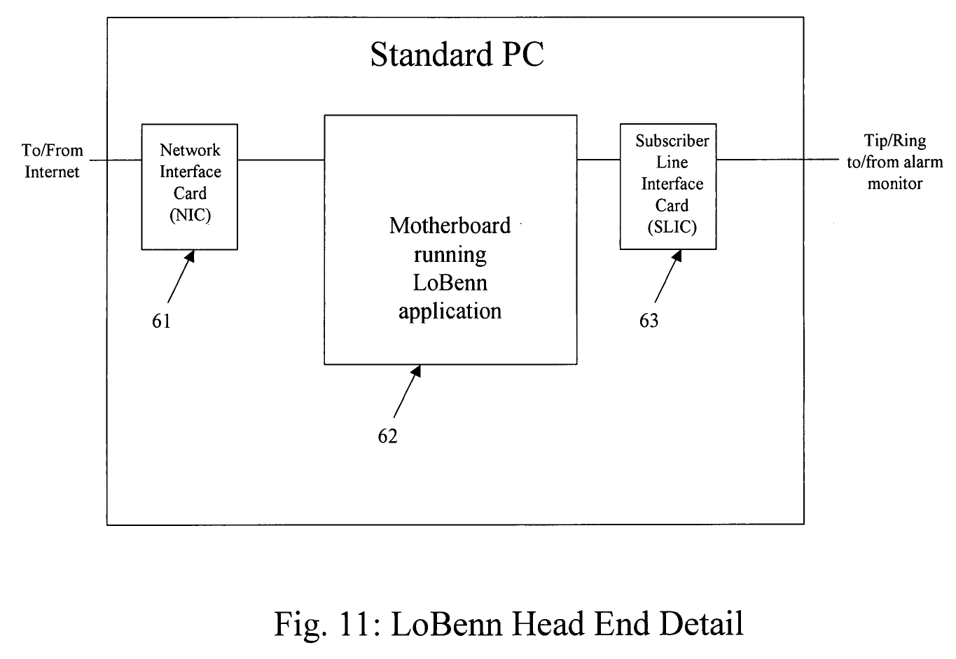

FIG. 11 shows the block diagram of the head end equipment, used to interface the incoming packet based data from the CPE unit detailed in FIG. 10 to the analog voice band interface of the monitoring center This equipment can be based on a standard personal computer or computer workstation. The Network Interface is a standard Ethernet based interface found in most computers, referred to as the Network Interface Card (NIC). The processing is provided by the microprocessor and memory circuitry of the motherboard. The interface to the monitoring equipment will be facilitated by the use of an industry standard Subscriber Line Interface Circuit (SLIC) card. These interfaces are designed to emulate the interface provided by the telephone office, and will appear to the monitoring equipment as another central office interface. The control code which will run on the microprocessor, providing the appropriate interface, encryption and communication commands will be part of this invention.

The head end portion of this system can be based on industry standard computers, with industry standard interface cards in them. All hardware including the network interface and the telephone interface can be purchased items from standard suppliers. Persons skilled in the art with a reasonable amount of software knowledge can design and build the hardware of the invention. Even the software can be based on elements, such as the SIP protocol and encryption algorithms, that are industry standards.

An advantage of the invention is that it may be readily retrofitted to existing systems. In the event of failure of the Internet link, the existing systems operate as they did previously through the telephone network.

### CONCLUSION

The foregoing has constituted a description of specific embodiments showing how the invention may be applied and put into use. These embodiments are only exemplary. The invention in its broadest, and more specific aspects is further described and defined in the claims which now follow.

These claims, and the language used therein, are to be understood in terms of the variants of the invention which have been described. They are not to be restricted to such variants, but are to be read as covering the full scope of the invention as is implicit within the invention and the disclosure that has been provided herein.

The embodiments of the invention in which an exclusive property or privilege is claimed are defined as follows:

1. In combination with an existing voice band data and voice communication source that includes a user phone for voice communication and which is connected through a telephone line and telephone central office to a remote receiving center through the telephone system, a communication interface coupled to said source that comprises means for enabling communication to occur over the Internet concurrently with the use of the telephone network.

2. In combination with an existing voice band data and voice communication source that includes a user phone for voice communication and which is connected through a telephone line and telephone central office to a remote receiving center through the telephone system, a communication interface coupled to said source by intercepting the telephone line extending between the source and the telephone central office, wherein:
a) the interface is connected to the user phone through a link, and
b) said interface incorporates telephone reconnection means to allow the user phone to be reconnected to the telephone line in the event of failure of the Internet connection.

3. A communication interface as in claim 2 comprising default circuitry which directs voice band data communication from the source to the remote receiving center through the Internet while the Internet link is operative, and which, in the condition of a failure of the Internet link, connects both data and voice signals from the communication source for transmission of signals through the telephone network.

4. A communication interface as in claim 1 comprising routing circuitry within the interface whereby, while both the telephonic and Internet link are operative, the interface may direct telephonic voice communication through either or both links.

5. A communication interface as in claim 1 whereby, while both the telephonic and Internet link are operative, the routing circuitry directs telephonic voice communication through the telephonic link.

6. A communication interface as in claim 1 wherein, while both the telephonic and Internet link are operative, the routing circuitry directs telephonic voice communication through the Internet link.

7. A communications link as in claim 1 wherein the communication interface is coupled to said source by intercepting the telephone line extending between the source and the telephone central office, wherein:
b) the interface is connected to the user phone through a link and
b) said interface incorporates telephone reconnection means to allow the user phone to be reconnected to the telephone in the event of failure of the Internet connection.

8. A communication interface as in claim 1 wherein the existing data and voice communication source is an alarm panel for a security system which includes a user phone coupled to said alarm panel and the remote receiving center is a security-monitoring center.

9. A communication interface as in claim 8 wherein the security monitoring center comprises means to regularly and repeatedly poll the user interface over the Internet link in order to ensure the integrity of the Internet link, and further comprises means to present an alert when the interface fails to respond to a polling prompt.

10. A communication interface as in claim 2 wherein the existing data and voice communication source is an alarm panel for a security system which includes a user phone coupled to said alarm panel and the remote receiving center is a security-monitoring center.

11. A communication interface as in claim 10 wherein the security monitoring center comprises means to regularly and repeatedly poll the user interface over the Internet link in order to ensure the integrity of the Internet link, and further comprises means to present an alert when the interface fails to respond to a polling prompt.

12. A communication interface as in claim 1 wherein the existing data and voice communication source is a point-of-sale credit/debit card data transmitter and wherein the user phone is coupled to share the telephonic link with said credit/debit card data transmitter and wherein the remote receiving center is an authorization center, said Interface comprising routing means which, while both the telephonic and Internet link are operative, can direct telephonic voice communication through either or both of said links, and which, upon failure of the Internet link, connects both data and voice signals from the credit card data transmitter and the user phone for transmission through the telephone network.

13. A communication interface as in claim 12 wherein said interface comprises default routing means that, in the event of failure of the Internet connection, causes the source to communicate over the pre-existing telephonic network connections.

14. A communication interface as in claim 2 wherein the existing data and voice communication source is a point-of-sale credit/debit card data transmitter and wherein the user phone is coupled to share the telephonic link with said credit/debit card data transmitter and wherein the remote receiving center is an authorization center, said Interface comprising routing means which, while both the telephonic and Internet link are operative, can direct telephonic voice communication through either or both of said links, and which, upon failure of the Internet link, connects both data and voice signals from the credit card data transmitter and the user phone for transmission through the telephone network.

15. A communication interface as in claim 14 wherein said interface comprises default routing means that, in the event of failure of the Internet connection, causes the source to communicate over the pre-existing telephonic network connections.

16. A communication interface as in claim 1 in combination with a data source transmission unit that incorporates a keypad input for controlling such units wherein the interface is connected to such unit so as to provide remote keyboard access to the unit through the Internet link.

17. A communication interface as in claim 2 in combination with a data source transmission unit that incorporates a keypad input for controlling such units wherein the interface is connected to such unit so as to provide remote keyboard access to the unit through the Internet link.

18. A communication interface as in claim 1 in combination with a data source transmission unit that incorporates a keypad input for controlling such units wherein the interface is connected to such unit so as to provide remote keyboard access to the unit through the Internet link.

19. A communication interface as in claim 8 in combination with a data source transmission unit that incorporates a keypad input for controlling such units wherein the interface is connected to such unit so as to provide remote keyboard access to the unit through the Internet link.

20. A communication interface as in claim 12 in combination with a data source transmission unit that incorporates a keypad input for controlling such units wherein the interface is connected to such unit so as to provide remote keyboard access to the unit through the Internet link.
